(19) United States
(12) Patent Application Publication
(10) Pub. No.: US 2009/0298617 A1
(43) Pub. Date: Dec. 3, 2009

(54) GOLF BALL MATERIAL AND GOLF BALL

(75) Inventors: Yoshinori EGASHIRA, Chichibu-shi (JP); Jun Shindo, Chichibu-shi (JP); Eiji Takehana, Chichibu-shi (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Sports Co., Ltd., Tokyo (JP)

(21) Appl. No.: 12/127,843

(22) Filed: May 28, 2008

(51) Int. Cl. A63B 37/12; A63B 37/00; C08L 9/00

(52) U.S. Cl. 473/378; 525/236

(57) ABSTRACT

The invention provides a golf ball material composed of a polymer material that contains spherical inorganic particulates, which is well adapted for use in at least one component of a golf ball composed of one or more layers. The golf ball material of the invention improves the flight performance of golf balls compared with polymer materials containing amorphous inorganic particulates.

### BACKGROUND OF THE INVENTION

The present invention relates to a golf ball material for use in a golf ball component, which is able to enhance the flight performance of the golf ball.

Fine particles, whether composed of an inorganic compound or an organic compound, are useful materials in golf balls. In particular, inorganic compounds in the form of fine particles (referred to below as “particulate inorganic compounds”), when dispersed in a polymer, are able to modify the polymer, making it useful as a golf ball material, for which purpose they have hitherto been employed.

Particulate inorganic compounds are commonly formulated for a variety of purposes in golf balls. Specifically, fine particles of titanium oxide, iron oxide, zinc oxide, barium sulfate, calcium sulfate, calcium carbonate, silica, talc, layered mica, layered mineral clay, glass, alumina, carbon black or graphite are used for such purposes as coloration, specific gravity control, material reinforcement (e.g., increasing hardness or tensile strength) or moistureproofing, and numerous patent applications describing such uses have been filed.

For example, U.S. Pat. No. 7,285,059 (Patent Document 1) and U.S. Pat. No. 6,972,310 (Patent Document 2) describe the use of titanium oxide, alumina and other oxides for the purpose of coloration, U.S. Pat. No. 7,202,303 (Patent Document 3) and U.S. Pat. No. 6,695,718 (Patent Document 4) describe the use of barium sulfate, tungsten, etc. to control specific gravity, U.S. Pat. No. 5,807,954 (Patent Document 5) and U.S. Pat. No. 6,634,963 (Patent Document 6) describe the use of kaolin, silica and other silicone oxides for the purpose of material reinforcement, and U.S. Pat. No. 7,025,696 (Patent Document 7) and U.S. Pat. No. 7,004,854 (Patent Document 8) describe the use of graphite, mica and other layered analogues for moistureproofing.

In recent years, with advances in technology, even among fine particles, spherical fine particles which have both a high sphericity and a small size are starting to be commercially produced. Examples include spherical silica fine particles, spherical alumina fine particles and spherical yttrium fine particles. For the sake of convenience, the terms “fine particles” and “particulate” refer herein to, from the standpoint of commercial production, particles which are not more than several tens of microns in size.

In the various applications for fine particles in the area of golf balls, when a filler in the form of fine particles is included within a polymer material, the general tendency has been for the flight performance of golf balls made of such a polymer material to be either comparable with or, more likely, inferior to the flight performance of golf balls made of a polymer material that does not contain such fine particles. Yet, no investigations or reports on improving the flight performance of golf balls made of polymer materials containing fine particles have appeared in the literature to date.

Patent Document 1: U.S. Pat. No. 7,285,059

Patent Document 2: U.S. Pat. No. 6,972,310

Patent Document 3: U.S. Pat. No. 7,202,303

Patent Document 4: U.S. Pat. No. 6,695,718

Patent Document 5: U.S. Pat. No. 5,807,954

Patent Document 6: U.S. Pat. No. 6,634,963

Patent Document 7: U.S. Pat. No. 7,025,696

Patent Document 8: U.S. Pat. No. 7,004,854

### SUMMARY OF THE INVENTION

One object of the invention is therefore to provide a golf ball material having a fine particle-containing polymer material which enhances the initial velocity and the coefficient of restitution of the ball and improves its flight performance. Another object of the invention is to provide a golf ball in which such a material is used.

The inventors have conducted surveys on various types of fine particles included in golf balls, in a field that is new to golf ball applications, i.e., on fine particle-containing polymer materials in which novel fine particles are included for the purpose of enhancing the flight performance of golf balls. As a result, they have found that fine particles having a shape which is spherical are the most suitable material for achieving the objects of the invention. That is, the inventors have found out that using a part made from a polymer material containing spherical fine particles as an essential golf ball component—i.e., as the cover material or core material in a solid two-piece golf ball composed of a core and a cover encasing the core, or as the cover material, intermediate layer material or core material in a solid multi-piece golf ball composed of a core of one or more layers, an intermediate layer of one or more layers encasing the core, and a cover of one or more layers encasing the intermediate layer—enables the initial velocity and the coefficient of restitution of the golf ball to be improved.

The present invention was arrived at as a result of intensive surveys on the question of whether or not, with regard to the golf ball properties ultimately obtained by including specific types of fine particles in a polymer material, the flight performance of the ball can be improved. Improvements in properties such as coloration, specific gravity control, material reinforcement and moistureproofing of the sort that have hitherto been carried out were not the object of the surveys.

Generally, as exemplified by fillers, there exist a great many types of fine particles used in golf balls. Conducting surveys on all of these would have been exceedingly difficult.

Ordinary fine particles are broadly divided into organic particulates such as polystyrene and polyacrylate, and inorganic particulates. Inorganic particulates include oxygen-containing inorganic compounds such as titanium oxide and barium sulfate, and non-oxygen-containing inorganic compounds such as tungsten silicide and aluminum nitride. The inventors thus focused their surveys on inorganic particulates.

Similarly, there exist a great many types of inorganic particulates. Testing and researching them all would be a formidable task. Because there are in addition a variety of expressions for the shapes—including the surface state, such as flakes, powder, solid, hollow, filled, unfilled, spherical, rod-shaped (cylindrical) and amorphous, and because additional methods of expression that relate to the internal structure—including noncrystalline and crystalline (e.g., tetragonal, orthorhombic, hexagonal)—also exist, classification is all the more daunting.

Therefore, in the present invention, inorganic particulates were classified according to shape relating to sphericity (degree of sphericity=maximum diameter/minimum diameter), size of the surface area (specific surface area) and existence or nonexistence of crystallinity, and typical inorganic particulates were selected from among these. The selected inorganic particulates were compounded in polymer materials, and the flight performances of golf balls made from the resulting fine particle-containing polymer materials were examined.

As a result, the following trends were observed among inorganic particulates which enhance the flight performance of the above-described golf balls.
(1) The flight performance of the golf ball improves as the fine particles are closer to sphere. In other words, it is preferable for the fine particles to have a shape which is spherical rather than amorphous.
(2) The above spherical fine particles have a sphericity (maximum diameter/minimum diameter) in a range of from about 1.00 to about 2.00, preferably from about 1.00 to about 1.50, and more preferably from about 1.00 to about 1.30.
(3) The above spherical fine particles (the material itself) have a thermal expansion coefficient (100° C., 5 hours) of at most about 2.0%, preferably at most about 1.5%, and more preferably at most about 1.0%.
(4) The above spherical fine particles have an average particle size in a range of from about 0.01 μm to about 100 μm, preferably from about 0.01 μm to about 50 μm, and more preferably from about 0.01 μm to about 25 μm.
(5) The above spherical fine particles have an average specific surface area in a range of from about 0.05 m²/g to about 115 m²/g, preferably from about 0.05 m²/g to about 100 m²/g, more preferably from about 0.5 m²/g to about 75 m²/g, and even more preferably from about 1.0 m²/g to about 50 m²/g.
(6) The above spherical fine particles have a specific gravity of preferably at least about 1.1, more preferably at least about 1.5, and even more preferably at least about 2.0.
(7) The structure of the spherical fine particles, i.e., whether the particles are crystalline or noncrystalline, has substantially no bearing on the flight performance.
(8) Golf balls in which a polymer material containing the above spherical fine particles is used have a coefficient of restitution which is at least about 0.1% higher than golf balls in which a polymer material containing amorphous fine particles is used.
(9) Golf balls in which a polymer material containing the above spherical fine particles is used have an initial velocity which is at least about 0.1% higher than golf balls in which a polymer material containing amorphous fine particles is used.

Accordingly, the invention provides the following golf ball materials and golf balls.

[1] A golf ball material comprising a polymer material that contains a spherical inorganic particulates, which is adapted for use in at least one component of a golf ball composed of one or more layers.
[2] The golf ball material of [1], wherein the spherical inorganic particulates has a sphericity, expressed as a ratio of maximum diameter to minimum diameter, in a range of from about 1.00 to about 2.00.
[3] The golf ball material of [1], wherein the spherical inorganic particulates has a thermal expansion coefficient, under the conditions of 5 hours at 100° C., of at most about 2.0%.
[4] The golf ball material of [1], wherein the spherical inorganic particulates has an average particle size in a range of from about 0.01 μm to about 100 μm.
[5] The golf ball material of [1], wherein the spherical inorganic particulates has an average specific surface area, as measured by the BET method, of from about 0.05 m²/g to about 115 m²/g.
[6] The golf ball material of [1], wherein the spherical inorganic particulates has a specific gravity of at least about 1.1.
[7] The golf ball material of [1], wherein the spherical inorganic particulates is an oxygen-containing inorganic compound.
[8] The golf ball material of [1], wherein the spherical inorganic particulates has a structure that is either crystalline or noncrystalline.
[9] The golf ball material of [1], wherein the polymer is a thermoplastic polymer and/or a thermoset polymer.
[10] The golf ball material of [9], wherein the thermoplastic polymer and/or the thermoset polymer is at least one polymer selected from the group consisting of polyolefin elastomers (including ethylenic ionomers, polyolefins and metallocene polyolefins), polystyrene elastomers, diene polymers, polyacrylate polymers, polyamide elastomers, polyurethane elastomers, polyester elastomers, polyacetals, thermoset urethanes and silicone polymers.
[11] The golf ball material of [10], wherein the spherical inorganic particulates is included in an amount of from about 0.1 parts by weight to about 30 parts by weight per 100 parts by weight of the thermoplastic polymer and/or the thermoset polymer.
[12] A golf ball comprising the golf ball material of any one of [1] to [11], wherein the golf ball material is used as a cover material or a core material in a solid two-piece golf ball comprising a core and a cover encasing the core, or as a cover material, an intermediate layer material or a core material in a solid multi-piece golf ball comprising a core of at least one layer, at least one intermediate layer encasing the core, and a cover of at least one layer encasing the intermediate layer.

### DETAILED DESCRIPTION OF THE INVENTION

The invention is described more fully below.

The golf ball material of the invention is characterized by being composed of a polymer material that contains a spherical inorganic particulates, and is adapted for use in at least one component of a golf ball composed of one or more layers.

The spherical inorganic particulates, while not subject to any particular limitation, is preferably an oxygen-containing inorganic compound. Suitable oxygen-containing inorganic compounds include, but are not limited to, metal oxides such as iron (III) oxide, zinc oxide, zirconium oxide, tungsten oxide, tin oxide, aluminum oxide (alumina), manganese oxide, titanium oxide, silicon oxide (e.g., silica gel, silica glass, quartz, coesite, cristobalite) and rare earth metal oxides or composite oxides (e.g., yttrium oxide, cerium oxide, lanthanum oxide, neodymium oxide, samarium oxide, yttrium europium double oxide); silicates such as aluminosilicates (including zeolites), potassium silicate, borosilicates, zirconium silicate, aluminoborosilicates, calcium metasilicate, zirconium silicate, talc, kaolin and clays; metal sulfates such as barium sulfate and zinc sulfate; sulfides such as zinc sulfide and molybdenum disulfide; metal carbonates such as calcium carbonate and zinc carbonate; and other compounds (including multiple oxides) such as barium titanate, sodium borate and synthetic hydrotalcite. Any one or combination of two or more of these can be used.

Spherical inorganic particulates other than the above oxygen-containing inorganic compounds include specialty inorganic compounds that do not contain oxygen, such as tungsten silicate, tungsten carbide, tungsten boride, titanium nitride, silicon nitride and aluminum nitride (ceramic).

The spherical inorganic particulates used in the invention have a sphericity (maximum diameter/minimum diameter) in a range of preferably from about 1.00 to about 2.00, more preferably from about 1.00 to about 1.50, and even more preferably from about 1.00 to about 1.30. The above sphericity is a numerical value obtained by measurement using a scanning electron microscopy (SEM) (magnification, 10,000; n=100). At a sphericity (maximum diameter/minimum diameter) in excess of the above range, the fine particles enter the amorphous region and, as with the prior art, may fail to provide any improvement in the flight performance of the ball.

The spherical inorganic particulates have an average particle size in a range of preferably from about 0.01 μm to about 100 μm, more preferably from about 0.01 μm to about 50 μm, and even more preferably from about 0.01 μm to about 25 μm. The particle size distribution is preferably from about 0.001 μm to about 1,000 μm, more preferably from about 0.001 μm to about 500 μm, and even more preferably from about 0.001 μm to about 300 μm. At an average particle size or particle size distribution which falls outside the above-indicated numerical ranges, an improvement in the flight performance of the ball can not be achieved.

The above-mentioned average particle size and particle size distribution are values obtained by particle size distribution measurement using a laser diffraction technique (laser diffraction/scattering).

The spherical inorganic particulates used in the present invention have a thermal expansion coefficient, under the conditions of 5 hours at 100° C., of preferably at most about 2.0%, more preferably at most about 1.5%, and even more preferably at most about 1.0%. When the spherical inorganic particulate-containing polymer material is formed, using an inorganic compound having a higher thermal expansion coefficient than the above-indicated range leads to the formation of gaps between the polymer material and the inorganic particulates. Consequently, impact energy transfer does not proceed smoothly, with the impact energy being instead consumed as energy which generates separation and cracks at such interfacial gaps between the polymer material and the inorganic particulates. As a result, an improvement in the flight performance can not be achieved.

The thermal expansion coefficient corresponds to the thermal expansion coefficient of the spherical inorganic particulate material, and is a value measured in accordance with JIS-R1618.

The spherical inorganic particulates have an average specific surface area in a range of preferably from about 0.05 m²/g to about 115 m²/g, more preferably from about 0.05 m²/g to about 100 m²/g, even more preferably from about 0.5 m²/g to about 75 m²/g, and most preferably from about 1.0 m²/g to about 50 m²/g. The numerical value for the specific surface area is a value measured by the BET method. By specifying the specific surface area of the spherical inorganic particulates as noted above, the surface state of the spherical fine particles included in the polymer material is optimized, enabling the objects and advantages of the invention to be successfully achieved.

The spherical inorganic particulates have a specific gravity of preferably at least about 1.1, more preferably at least about 1.5, and even more preferably at least about 2.0. Spherical inorganic particulates having a specific gravity lower than the above will be included in a higher amount in the polymer material, thereby tending to lower the flight performance-improving effect. On the other hand, as the specific gravity becomes higher, the amount of the spherical inorganic particulates included in the polymer material will decrease, thereby tending to improve the flight performance.

Illustrative examples of the spherical fine particles of the invention include, but are not limited to, the following. Examples of spherical silica include HS-301 (average particle size, 2.4 μm; BET value, about 8.0 m²/g), HS-303 (average particle size, 9.5 μm; BET value, about 1.3 m²/g), HS-304 (average particle size, 24.9 μm; BET value, about 0.7 m²/g), and HS-305 (average particle size, 83.6 μm; BET value, about 0.4 m²/g) (all noncrystalline and available from Micron Co., Ltd.); SO-E1 (average particle size, 0.25 μm; BET value, about 16.1 m²/g) and SO-E6 (average particle size, 2.0 μm; BET value, about 2.2 m²/g) (both noncrystalline and available from Admatechs Co., Ltd.); UFP-30 (average particle size, 0.03 μm; BET value, about 35 m²/g) and SFP-30M (average particle size, 0.7 μm; BET value, about 6.2 m²/g) (both noncrystalline and available from Denki Kagaku Kogyo K.K.); and KE-P10 (average particle size, 0.1 μm; BET value, about 26 m²/g), KE-P50 (average particle size, 0.5 μm; BET value, about 15 m²/g), and KE-P250 (average particle size, 2.5 μm; BET value, about 9.0 m²/g) (both noncrystalline and available from Nippon Shokubai Co., Ltd.).

Examples of spherical alumina include AX3-32 (average particle size, about 3.5 μm; BET value, about 0.6 m²/g), AX10-32 (average particle size, 10.0 μm; BET value, about 0.3 m²/g) and AW70-125 (average particle size, 67.0 μm; BET value, about 0.1 m²/g) (all crystalline and available from Micron Co., Ltd.); AO-802 (average particle size, 0.7 μm; BET value, about 6.0 m²/g), AO-809 (average particle size, 10 μm; BET value, about 1.0 m²/g) and AO-820 (average particle size, 20 μm; BET value, about 0.7 m²/g) (all noncrystalline and available from Admatechs Co., Ltd.); and ASFP-20 (average particle size, 0.2 μm; BET value, about 15 m²/g), DAM-05 (average particle size, 5 μm; BET value, about 0.5 m²/g), DAM-45 (average particle size, 45 μm; BET value, about 0.2 m²/g) and DAM-70 (average particle size, 70 μm; BET value, about 0.1 m²/g) (all noncrystalline and available from Denki Kagaku Kogyo K.K.).

Examples of spherical rare earth metal oxides include yttrium oxide (average particle size, 1.0 μm; BET value, about 12 m²/g) (available from Nippon Yttrium Co., Ltd.); and samarium oxide (average particle size, 0.3 μm or 0.05 μm; BET value, about 11 m²/g or about 98 m²/g), cerium oxide (average particle size, 0.1 μm; BET value, about 114 m²/g) and yttrium europium composite oxide (average particle size, 0.4 μm; BET value, about 3.0 m²/g) (all available from Shin-Etsu Chemical Co., Ltd.).

Additional examples include spherical titanium oxide (average particle size, 0.2 μm; experimental product; BET value, about 15 m²/g) (available from Toho Titanium Co., Ltd.), spherical aluminum nitride (average particle size, 1.2 μm; BET value, about 2.6 m²/g (available from Toyo Aluminium KK.), spherical calcium carbonate (average particle size, 3.0 μm; BET value, about 2.2 m²/g) (available from Newlime Co., Ltd.) and spherical barium titanate (average particle size, 0.2 μm; experimental product; BET value, about 5.1 m²/g) (available from Toda Kogyo Corp.).

The polymer material which includes the spherical inorganic particulates of the invention, while not subject to any particular limitation, is typically a thermoplastic polymer and/or a thermoplastic polymer used in the golf ball. Illustrative examples of thermoplastic polymers include polyolefin elastomers (including ethylenic ionomers, polyolefins and metallocene polyolefins), polystyrene elastomers, diene polymers, polyacrylate polymers, polyamide elastomers, polyurethane elastomers, polyester elastomers, polyacetals. Illustrative examples of thermoset polymers include thermoset urethanes and silicone polymers. Any one or combinations of two or more of these polymers can be used.

The above-described spherical inorganic particulates are included in the above polymer material in an amount of preferably at least about 0.1 part by weight, and more preferably at least about 0.5 part by weight, per 100 parts by weight of the polymer. The upper limit is preferably not more than about 30 parts by weight, and more preferably not more than about 20 parts by weight. Beyond these values, control of the golf ball weight within the standard range becomes difficult, in addition to which the golf ball flight performance-improving effects due to incorporation of the spherical fine particles may be too fading.

To enhance the dispersibility of spherical inorganic particulates in the above polymer material, can the particulates be used, of which the surface is treated with an agent such as a higher fatty acid (e.g., stearic acid, behenic acid), a silane coupling agent (e.g., triethoxyvinylsilane, 3-glycidylpropyltrimethoxysilane), etc., and in case of useful spherical titanium oxide, its surface is coated with tin oxide.

The method for incorporating the spherical fine particles of the invention into the above-described polymer material by melt blending is preferably carried out using a vented twin-screw extruder having arranged thereon a screw segment with a kneading disc zone. In such a case, it is advantageous to use a twin-screw extruder having an L/D ratio for the overall screw of at least 25 and a kneading disc zone L/D ratio which is in a range of from 20 to 80% of the overall L/D ratio.

The temperature when melt-blending the spherical inorganic particulates of the invention with the polymer material is preferably in a range of about 100° C. to about 250° C., more preferably in a range of about 130° C. to about 240° C., and even more preferably in a range of about 150° C. to about 230° C.

The golf ball material of the invention can additionally include optional additives as appropriate for the intended use. When the inventive golf ball material is to be used as a cover material, various additives such as pigments, dispersants, antioxidants, ultraviolet absorbers and light stabilizers can be added to the polymer material containing the above-described spherical inorganic particulates. When such additives are included, they can be added in an amount of generally at least 0.1 part by weight, and preferably at least 0.5 part by weight, but generally not more than 10 parts by weight, and preferably not more than 5 parts by weight, per 100 parts by weight of the total amount of the spherical inorganic particulate-containing polymer material.

The golf ball material of the invention has a specific gravity which is generally at least 0.9, preferably at least 0.92, and more preferably at least 0.94, but generally not more than 1.3, preferably not more than 1.2, and further preferably not more than 1.05.

Parts obtained from a polymer material containing the spherical inorganic particulates used as a golf ball material in the invention have a Shore D hardness of generally at least 35, and preferably at least 40, but generally not more than 75, and preferably not more than 70. If the Shore D hardness is too high, the golf ball that has been formed may have a significantly diminished feel on impact. On the other hand, if the Shore D hardness is too low, the coefficient of restitution of the golf ball may decrease.

The polymer material having spherical inorganic particulates applicable to a golf ball material in the invention can be used as a cover material or a core material in a two-piece solid golf ball composed of a core and a cover encasing the core, or may be used as a cover material, an intermediate layer material or a core material in a multi-piece solid golf ball composed of a core of at least one layer, at least one intermediate layer encasing the core, and a cover of at least one layer encasing the intermediate layer.

When a polymer material containing the spherical inorganic particulates of the invention is used as a golf ball component, the golf ball has a coefficient of restitution which is improved by at least about 0.1% relative to a golf ball which uses a polymer material containing amorphous inorganic particulates. Moreover, golf balls made by using a spherical inorganic particulates-containing polymer material have an initial velocity which is improved by at least about 0.1% relative to a golf ball which uses a polymer material containing amorphous fine particles.

As explained above, compared with polymer materials containing an amorphous spherical inorganic particulates, the golf ball material of the invention is able to improve the flight performance of the golf ball.

### EXAMPLES

Examples of the invention are provided below by way of illustration and not by way of limitation. The twin-screw extruder used in the examples had a screw diameter of 32 mm, an overall L/D ratio of 41 and an L/D ratio in the kneading disc zone which was 40% of the overall L/D ratio, and was equipped with a vacuum-venting port.

### Example 1

A dry blend of Polymer-A composed of two types of ionomers and the spherical titanium oxide (average particle size, about 0.2 μm) formulated as shown in Table 1 was fed to the hopper of a twin-screw extruder set at 220° C. and extruded under vacuum venting, thereby giving the uniform ionomer blend composition referred to as the “Ion1” material below (screw revolution speed, 125 rpm; extrusion rate, 5.0 kg/hr). Using this Ion1 material as the cover material for two-piece golf balls and using a crosslinked butadiene body (diameter, 39.3 mm; weight, 36.9 g; deflection, 3.25 mm) as the core, two-piece golf balls were fabricated by injection molding. The initial velocity and the coefficient of restitution (referred to as “flight performance” below) of these golf balls were evaluated. The results are shown in Table 1.

The core (crosslinked butadiene body) was formulated as follows.

| | | |
|---|---|---|
| cis-1,4-Polybutadiene rubber | 100 | parts by weight |
| Zinc acrylate | 21 | parts by weight |
| Zinc oxide | 5 | parts by weight |
| Barium sulfate | 26 | parts by weight |
| Dicumyl peroxide | 0.8 | part by weight |

The golf balls in Example 1 obtained from the Ion1 material had an improved flight performance compared with the two-piece golf balls in Control Example 1 obtained from the Ion9 material containing amorphous titanium oxide having the same average particle size.

### Example 2

Aside from using the spherical titanium oxide having a large average particle size (average particle size, about 80 μm) instead of the spherical titanium oxide used in Example 1, the same procedure was followed as in Example 1 using the same formulation as in Example 1, thereby giving the uniform ionomer blend composition referred to as the “Ion2” material below. Two-piece golf balls were produced using this material, and the flight performance of the golf balls was evaluated. The results are shown in Table 1. The spherical titanium oxide having a large average particle size (average particle size, about 80 μm) included, in the particle size distribution, several tens of percent of spherical particles 100 μm or larger in size. As a result, the flight performance was not improved as much as with the use of the Ion1 material in Example 1. However, there was some improvement compared to Control Example 1.

### Example 3

Aside from using, in the proportions shown in Table 1, the spherical titanium oxide used in Example 1 (average particle size, about 0.2 μm) and the amorphous titanium oxide used in Comparative Example 1 (average particle size, about 0.2 μm), the same procedure was followed as in Example 1, thereby giving the uniform “Ion3” material. Two-piece golf balls were produced using this material, and the flight performance of the balls was evaluated. The results are shown in Table 1. Compounding the spherical titanium oxide together with the amorphous titanium oxide resulted in a considerable improvement in the flight performance compared with Control Example 1.

### Example 4

Aside from using the spherical silica (average particle size, about 1.1 μm) instead of the spherical titanium oxide of Example 3 (average particle size, about 0.2 μm), together with the amorphous titanium oxide used in Control Example 1 (average particle size, about 0.2 μm) as well as in Example 3, the same procedure was followed as in Example 3, thereby giving the uniform “Ion4” material.

Two-piece golf balls were produced using this material, and the flight performance of the balls was evaluated. The results are shown in Table 1. Compounding the spherical silica which is even a different kind of material from the titanium oxide together with the amorphous titanium oxide resulted in a flight performance-improving effect similar to that observed in Example 3.

### Example 5

Aside from using the spherical silica (average particle size, about 1.1 μm) instead of the spherical titanium oxide of Example 1, the same procedure was followed as in Example 1 using the proportions shown in Table 1, thereby giving the uniform “Ion5” material. Two-piece golf balls were produced using this material, and the flight performance of the balls was evaluated. The results are shown in Table 1. Compared with Control Example 1 and with Control Example 2 in which the amorphous silica (average particle size, about 1.0 μm) was used, the flight performance was greatly improved.

### Example 6

Aside from using the spherical silica having an even larger particle size (average particle size, about 25 μm) than the spherical silica used in Example 5, the same procedure was followed as in Example 5, thereby giving the uniform “Ion6” material. Two-piece golf balls were produced using this material, and the flight performance of the balls was evaluated. The results are shown in Table 1. Compared with Control Example 2 in which the amorphous silica (average particle size, about 1.0 μm) was used, the flight performance was greatly improved.

### Example 7

Aside from using the spherical silica oxide having a still larger particle size (average particle size, about 84 μm) than the spherical silica used in Example 6, the same procedure was followed as in Example 5, giving the uniform “Ion7” material. Two-piece golf balls were produced using this material, and the flight performance of the balls was evaluated. The results are shown in Table 1. The spherical silica oxide having a large average particle size (about 84 μm) included, in the particle size distribution, several tens of percent of spherical particles at least 100 μm in size. As a result, the flight performance was not improved as much as with the use of the Ion5 material in Example 5. However, there was some improvement compared to Control Example 2.

### Example 8

Aside from using Polymer-B, which is composed of a thermoplastic urethane and an ionomer, instead of the Polymer-A of Example 1, and aside from using the spherical alumina (average particle size, about 0.7 μm) instead of the spherical titanium oxide of that, the same procedure was followed as in Example 1 using the proportions shown in Table 1, thereby giving the uniform “TPU-Ion1” material. Two-piece golf balls were produced using the TPU-Ion1 material, and the flight performance of the balls was evaluated. The results are shown in Table 1. Compared with Control Example 3, in which the amorphous alumina (average particle size, about 0.6 μm) was used, the flight performance was greatly improved.

### Example 9

Aside from using the spherical alumina having an even larger average particle size (average particle size, about 25 μm) than the spherical alumina used in Example 8, the same procedure was followed as in Example 8, thereby giving the uniform “TPU-Ion2” material. Two-piece golf balls were produced using the TPU-Ion2 material, and the flight performance of the balls was evaluated. The results are shown in Table 1. Compared with Control Example 3, in which the amorphous alumina (average particle size, about 0.6 μm) was used, the flight performance was improved.

### Example 10

Aside from using the spherical alumina having an even larger average particle size (average particle size, about 67 μm) than the spherical alumina used in Example 9, the same procedure was followed as in Example 8, thereby giving the uniform “TPU-Ion3” material. Two-piece golf balls were produced using the TPU-Ion3 material, and the flight performance of the balls was evaluated. The results are shown in Table 1. The spherical alumina having a large average particle size (about 67 μm) included, in the particle size distribution, several percent of spherical particles at least 100 μm in size. As a result, the flight performance was not improved as much as with the use of the TPU-Ion1 material in Example 8. However, there was some improvement compared to Control Example 3.

### Example 11

Aside from using Polymer-C, which is composed of a polybutadiene and an ionomer, instead of the Polymer-A of Example 1, and aside from using the spherical yttrium oxide (average particle size, about 0.3 μm) instead of the spherical titanium oxide, the same procedure was followed as in Example 1 using the proportions shown in Table 1, thereby giving the uniform “BR-Ion1” material. Two-piece golf balls were produced using the BR-Ion1 material, and the flight performance of the balls was evaluated. The results are shown in Table 1. Compared with Control Example 4, in which amorphous yttrium oxide (average particle size, about 0.3 μm) was used, the flight performance was improved.

### Example 12

Aside from using the spherical aluminum nitride (average particle size, about 1.2 μm) instead of the spherical yttrium oxide used in Example 11, the same procedure was followed as in Example 11 using the proportions shown in Table 1, thereby giving the uniform “BR-Ion2” material. Two-piece golf balls were produced using the BR-Ion2 material, and the flight performance of the balls was evaluated. The results are shown in Table 1. Compared with Control Example 5, in which the amorphous aluminum nitride (average particle size, about 1.1 μm) was used, the flight performance was improved.

### Example 13

During preparation of the thermoset aromatic polyurethane blend material Polymer-D composed primarily of polytetramethylene glycol(PTMG)-blocked diphenylmethane diisocyanate(MDI)urethane prepolymer/4,4′-methylenebis-(2,6-diethyl)aniline/N,N′-dimethylamino-diphenylmethane/trimethylolpropane=100/50/50/3 (weight ratio), the spherical barium titanate (average particle size, about 0.5 μm) was added in the proportions shown in Table 1, thereby giving the “TPU1” material, which was used to produce two-piece golf balls under liquid injection and curing. The flight performance of the balls was evaluated. The results are shown in Table 1. Compared with Control Example 6, in which the amorphous barium titanate (average particle size, about 0.4 μm) was used, the flight performance was improved.

### Example 14

The spherical calcium carbonate (average particle size, about 3.0 μm) was compounded in the proportions indicated in Table 1 with the polybutadiene blend material Polymer-E composed primarily of polybutadiene/zinc acrylate/zinc oxide/barium sulfate/peroxide (dicumyl peroxide)=100/20/5/15/0.8 (parts by weight), following which the resulting material was molded into one-piece cores (BR1) under heat (150° C.) and pressure. The flight performance of the cores was evaluated. The results are shown in Table 1. Compared with Control Example 7, in which the amorphous calcium carbonate (average particle size, about 3.0 μm) was used, the flight performance was improved.

### Reference Example

As a reference example, two-piece golf balls made of Polymer-A alone (Ion8), i.e., containing no spherical or amorphous particles, were produced by the method of Example 1, and the flight performance of the golf balls was evaluated. The results are shown in Table 2. The flight performance was enhanced compared with Control Example 1 in which the amorphous titanium oxide (average particle size, about 0.2 μm) was included. Conversely, Control Example 1 showed a general tendency that the flight performance declines when amorphous particles (commonly referred to as a filler) are included in the polymer material.

### Control Example 1

As a control for Examples 1 to 4, aside from including the amorphous titanium oxide (average particle size, about 0.2 μm) instead of the spherical titanium oxide, the same procedure was followed as in Example 1, thereby giving the “Ion9” material. Two-piece golf balls were produced using the Ion9 material, and the flight performance of the balls was evaluated. The results are shown in Table 2. The flight performance in Control Example 1 using the Ion9 material was lower than that in Examples 1 to 4. Hence, a general tendency was observed that the flight performance decreases when amorphous particles (commonly referred to as a filler) are included in the polymer material.

### Control Examples 2 to 5

Control Examples 2 to 5 were carried out as controls for Examples 5 to 12. Aside from using the amorphous particulate materials having the minimum average particle size of, or having substantially the same average particle size as, the respective spherical particulate materials in the examples, the same procedure was followed as in Example 1, thereby obtaining the respective materials Ion10, TPU-Ion4, BR-Ion3 and BR-Ion4. These materials were used to produce two-piece golf balls in Control Examples 2 to 5. The flight performances of these two-piece golf balls were evaluated. The results are shown in Table 2. The flight performances of the golf balls obtained in Control Examples 2 to 5 using the amorphous particulate materials were inferior to those of the golf balls obtained in Examples 5 to 12. Hence, a general tendency was observed that the flight performance decreases when amorphous particles (commonly referred to as a filler) are included in the polymer material.

### Control Examples 6 and 7

Control Examples 6 and 7 were carried out as controls for Examples 13 and 14, respectively. Aside from using the amorphous particles having substantially the same average particle sizes as the spherical particles in the respective examples, the same procedure was followed as in the respective corresponding examples, thereby giving, respectively, the materials TPU2 and BR2 (core). The TPU2 material was used to produce two-piece golf balls by the same procedure as in Example 13. The respective flight performances of these two-piece golf balls and BR2 (core) were evaluated. The results are shown in Table 2. The flight performances of the balls in Comparative Examples 6 and 7 which contained the amorphous particulate materials were inferior to those in the respective corresponding Examples 13 and 14.

TABLE 1

| Items | | | | | | | | | |
|---|---|---|---|---|---|---|---|---|---|
| | | Average | | | | | | | |
| | | particle | Example | | | | | | |
| | Particles' | size | 1 | 2 | 3 | 4 | 5 | 6 | 7 |
| Particles | shape | (μm) | Ion1 | Ion2 | Ion3 | Ion4 | Ion5 | Ion6 | Ion7 |
| CaCO₃ | Sphere | 3.0 | — | — | — | — | — | — | — |
| | Amorphous | 3.0 | — | — | — | — | — | — | — |
| BaTiO₃ | Sphere | 0.5 | — | — | — | — | — | — | — |
| | Amorphous | 0.4 | — | — | — | — | — | — | — |
| AIN | Sphere | 1.2 | — | — | — | — | — | — | — |
| | Amorphous | 1.1 | — | — | — | — | — | — | — |
| Y₂O₃ | Sphere | 0.3 | — | — | — | — | — | — | — |
| | Amorphous | 0.3 | — | — | — | — | — | — | — |
| Al₂O₃ | Sphere | 67 | — | — | — | — | — | — | — |
| | Sphere | 25 | — | — | — | — | — | — | — |
| | Sphere | 0.7 | — | — | — | — | — | — | — |
| | Amorphous | 0.6 | — | — | — | — | — | — | — |
| SiO₂ | Sphere | 84 | — | — | — | — | — | — | 4.0 |
| | Sphere | 25 | — | — | — | — | — | 4.0 | — |
| | Sphere | 1.1 | — | — | — | 2.0 | 4.0 | — | — |
| | Amorphous | 1.0 | — | — | — | — | — | — | — |
| TiO₂ | Sphere | 80 | — | 4.0 | — | — | — | — | — |
| | Sphere | 0.2 | 4.0 | — | 2.0 | — | — | — | — |
| | Amorphous | 0.2 | — | — | 2.0 | 2.0 | — | — | — |
| Polymer-E | | | — | — | — | — | — | — | — |
| Polymer-D | | | — | — | — | — | — | — | — |
| Polymer-C | | | — | — | — | — | — | — | — |
| Polymer-B | | | — | — | — | — | — | — | — |
| Polymer-A | | | A | A | A | A | A | A | A |
| GB Diameter (42.65-42.75 mm) | | | 42.75 | 42.74 | 42.74 | 42.75 | 42.75 | 42.74 | 42.74 |
| GB Weight (44.80-45.60 g) | | | 45.60 | 45.59 | 45.60 | 45.60 | 45.58 | 45.59 | 45.59 |
| Deflection (mm) | | | 2.72 | 2.72 | 2.72 | 2.73 | 2.73 | 2.72 | 2.72 |
| Initial Velocity (m/sec) | | | 76.49 | 76.34 | 76.43 | 76.59 | 76.56 | 76.49 | 76.34 |
| C.O.R. | | | 0.773 | 0.769 | 0.771 | 0.775 | 0.774 | 0.770 | 0.769 |
| Shot Number (Durability) | | | 91 | 90 | 91 | 91 | 99 | 92 | 90 |
| Items | | | | | | | | | |
| | | Average | Example | | | | | | |
| | | particle | 8 | 9 | 10 | 11 | 12 | | |
| | Particles' | size | TPU- | TPU- | TPU- | BR- | BR- | 13 | 14 |
| Particles | shape | (μm) | Ion1 | Ion2 | Ion3 | Ion1 | Ion2 | TPU1 | BR1 |
| CaCO₃ | Sphere | 3.0 | — | — | — | — | — | — | 10.0 |
| | Amorphous | 3.0 | — | — | — | — | — | — | — |
| BaTiO₃ | Sphere | 0.5 | — | — | — | — | — | 3.0 | — |
| | Amorphous | 0.4 | — | — | — | — | — | — | — |
| AIN | Sphere | 1.2 | — | — | — | — | 3.0 | — | — |
| | Amorphous | 1.1 | — | — | — | — | — | — | — |
| Y₂O₃ | Sphere | 0.3 | — | — | — | 2.5 | — | — | — |
| | Amorphous | 0.3 | — | — | — | — | — | — | — |
| Al₂O₃ | Sphere | 67 | — | — | 3.0 | — | — | — | — |
| | Sphere | 25 | — | 3.0 | — | — | — | — | — |
| | Sphere | 0.7 | 3.0 | — | — | — | — | — | — |
| | Amorphous | 0.6 | — | — | — | — | — | — | — |
| SiO₂ | Sphere | 84 | — | — | — | — | — | — | — |
| | Sphere | 25 | — | — | — | — | — | — | — |
| | Sphere | 1.1 | — | — | — | — | — | — | — |
| | Amorphous | 1.0 | — | — | — | — | — | — | — |
| TiO₂ | Sphere | 80 | — | — | — | — | — | — | — |
| | Sphere | 0.2 | — | — | — | — | — | — | — |
| | Amorphous | 0.2 | — | — | — | — | — | — | — |

| | | | | | | | |
|---|---|---|---|---|---|---|---|
| Polymer-E | — | — | — | — | — | — | E |
| Polymer-D | — | — | — | — | — | D | — |
| Polymer-C | — | — | — | C | C | — | — |
| Polymer-B | B | B | B | — | — | — | — |
| Polymer-A | — | — | — | — | — | — | — |
| GB Diameter (42.65-42.75 mm) | 42.68 | 42.68 | 42.67 | 42.70 | 42.70 | 42.70 | 39.3 |
| GB Weight (44.80-45.60 g) | 45.58 | 45.59 | 45.58 | 45.52 | 45.50 | 45.33 | 36.9 |
| Deflection (mm) | 2.81 | 2.82 | 2.81 | 2.91 | 2.89 | 2.97 | 3.23 |
| Initial Velocity (m/sec) | 77.70 | 77.61 | 77.56 | 76.62 | 76.64 | 77.45 | 77.34 |
| C.O.R. | 0.775 | 0.772 | 0.770 | 0.771 | 0.773 | 0.803 | 0.811 |
| Shot Number (Durability) | 179 | 164 | 158 | 96 | 0.773 | 201 | 178 |

TABLE 2

| Items | | | | | | | | | | |
|---|---|---|---|---|---|---|---|---|---|---|
| | | Average | | Control | | | | | | |
| | | particle | | | | 3 | 4 | 5 | | |
| | Particles' | size | Reference | 1 | 2 | TPU- | BR- | BR- | 6 | 7 |
| Particles | shape | (μm) | Ion8 | Ion9 | Ion10 | Ion4 | Ion3 | Ion4 | TPU2 | BR2 |
| CaCO₃ | Sphere | 3.0 | — | — | — | — | — | — | — | — |
| | Amorphous | 3.0 | — | — | — | — | — | — | — | 10.0 |
| BaTiO₃ | Sphere | 0.5 | — | — | — | — | — | — | — | — |
| | Amorphous | 0.4 | — | — | — | — | — | — | 3.0 | — |
| AIN | Sphere | 1.2 | — | — | — | — | — | — | — | — |
| | Amorphous | 1.1 | — | — | — | — | — | 3.0 | — | — |
| Y₂O₃ | Sphere | 0.3 | — | — | — | — | — | — | — | — |
| | Amorphous | 0.3 | — | — | — | — | 2.5 | — | — | — |
| Al₂O₃ | Sphere | 67 | — | — | — | — | — | — | — | — |
| | Sphere | 25 | | — | — | — | — | — | — | — |
| | Sphere | 0.7 | — | — | — | — | — | — | — | — |
| | Amorphous | 0.6 | — | — | — | 3.0 | — | — | — | — |
| SiO₂ | Sphere | 84 | — | — | — | — | — | — | — | — |
| | Sphere | 25 | — | — | — | — | — | — | — | — |
| | Sphere | 1.1 | — | — | — | — | — | — | — | — |
| | Amorphous | 1.0 | — | — | 4.0 | — | — | — | — | — |
| TiO₂ | Sphere | 80 | — | — | — | — | — | — | — | — |
| | Sphere | 0.2 | — | — | — | — | — | — | — | — |
| | Amorphous | 0.2 | — | 4.0 | — | — | — | — | — | — |

| | | | | | | | | |
|---|---|---|---|---|---|---|---|---|
| Polymer-E | — | — | — | — | — | — | — | E |
| Polymer-D | — | — | — | — | — | — | D | — |
| Polymer-C | — | — | — | — | C | C | — | — |
| Polymer-B | — | — | — | B | — | — | — | — |
| Polymer-A | A | A | A | — | — | — | — | — |
| GB Diameter (42.65-42.75 mm) | 42.71 | 42.74 | 42.74 | 42.67 | 42.70 | 42.70 | 42.70 | 39.3 |
| GB Weight (44.80-45.60 g) | 45.43 | 45.59 | 45.57 | 45.58 | 45.52 | 45.50 | 45.33 | 36.9 |
| Deflection (mm) | 2.73 | 2.72 | 2.72 | 2.81 | 2.91 | 2.89 | 2.98 | 3.23 |
| Initial Velocity (m/sec) | 76.34 | 76.30 | 76.32 | 77.54 | 76.49 | 76.50 | 77.31 | 77.19 |
| C.O.R. | 0.769 | 0.768 | 0.768 | 0.769 | 0.766 | 0.766 | 0.791 | 0.800 |
| Shot Number (Durability) | 81 | 90 | 92 | 151 | 89 | 91 | 193 | 163 |

Descriptions are provided below on the materials and the measurement methods mentioned in Tables 1 and 2.

| | | | |
|---|---|---|---|
| CaCO₃ | Calcium | Sphere | Newlime Co.; development product; vaterite crystals; |
| | carbonate | | particle size, about 3 μm |
| | | Amorphous | Hayashi-Kasei Co.; Escalon #200; |
| | | | particle size, about 3 μm |
| BaTiO₃ | Barium | Sphere | Toda Kogyo Corp.; development product; |
| | titanate | | particle size, about 0.5 μm |
| | | Amorphous | KCM Corporation; BT-HP9DX; |
| | | | particle size, about 0.4 μm |
| AlN | Aluminum | Sphere | Toyo Aluminium KK; JC; |
| | nitride | | particle size, about 1.2 μm |
| | | Amorphous | Tokuyama Corp.; H; |
| | | | particle size, about 1.1 μm |
| Y₂O₃ | Yttrium | Sphere | Shin-Etsu Chemical; experimental product; |
| | oxide | | particle size, about 0.3 μm |
| | | Amorphous | Junsei Chemical Co.; reagent; |
| | | | particle size, about 0.3 μm |
| Al₂O₃ | Alumina | Sphere | Micron Co.; AX-25; particle size, about 25 μm |
| | | | AW70-125; particle size, about 67 μm |
| | | Sphere | Shin-Etsu Quartz; AO-802; |
| | | | particle size, about 0.7 μm |
| | | Amorphous | Showa Denko; AL-160SG-3; |
| | | | particle size, about 0.6 μm |
| SiO₂ | Silica | Sphere | Micron Co.; HS-304; particle size, about 24.9 μm |
| | | | HS-305; particle size, about 83.6 μm |
| | | Sphere | Nippon Shokubai; KE-P100; |
| | | | particle size, about 1.1 μm |
| | | Amorphous | Hayashi-Kasei Co.; AQ-PL2; |
| | | | particle size, about 1.0 μm |
| TiO₂ | Titanium | Sphere | Toho Titanium Co.; development product; |
| | oxide | | particle size, about 0.2 μm |
| | | | HTG100; particle size, about 80 μm |
| | | Amorphous | Ishihara Sangyo Kaisha; PF737; |
| | | | particle size, about 0.2 μm |

Note:
In the table, “particle size” refers to the average particle size

The specific gravities of the above spherical inorganic particulates are as follows: CaCO₃ (specific gravity, 2.8); BaTiO₃ (specific gravity, 6.1); AlN (specific gravity, 3.3); Y₂O₃ (specific gravity, 5.0); Al₂O₃ (specific gravity, 3.6); SiO₂ (specific gravity, 2.0); TiO₂, (specific gravity, 4.0).

### Polymer-A

The ionomer blend composition:
S9945/S8940/blue pigment=40/60/0.05 parts by weight
S9945, S8940 (ionomers available from DuPont)
Blue pigment (Pigment Blue 29, available from Toyo Ink Mfg. Co., Ltd.)

### Pigment-B

The thermoplastic urethane-ionomer blend composition:
Thermoplastic urethane/Mg-ionomer=20/80 parts by weight
Thermoplastic urethane (an aliphatic urethane available from DIC-Bayer)
Mg-ionomer (an experimental product of Bridgestone Sports Co., Ltd.)

### Polymer-C

The polybutadiene-ionomer blend composition:
Polybutadiene blend/Zn-ionomer=10/90 parts by weight
Polybutadiene blend (BR01/maleic anhydride/peroxide=100/2/1 parts by weight)
BR01 (polybutadiene having a cis-1,4-bond content of at least 96%; available from JSR Corporation)
Peroxide (dicumyl peroxide, available from NOF Corporation
Zn-ionomer (an experimental product of Bridgestone Sports Co., Ltd.)

### Polymer-D

The thermoset urethane blend composition:
PTMG (polytetramethylene glycol)-blocked MDI (diphenylmethane diisocyanate)urethane prepolymer (NCO, 7.5 wt %)/4,4′-methylenebis-(2,6-diethyl)-aniline/N,N′-dimethylamino-diphenylmethane/trimethylolpropane=100/50/50/3 parts by weight
PTMG-blocked MDI urethane prepolymer (an aromatic urethane available from DIC-Bayer)
4,4′-Methylenebis-(2,6-diethyl)aniline (Junsei Chemical)
N,N′-Dimethylamino-diphenylmethane (Junsei Chemical)
Trimethylolpropane (Mitsubishi Gas Chemical)

### Polymer E

The polybutadiene blend composition:
Polybutadiene/zinc acrylate/zinc oxide/barium sulfate/peroxide=100/20/5/15/0.8 parts by weight
Polybutadiene (BR01; available from JSR Corporation)
Zinc acrylate (Nippon Shokubai Co., Ltd.)
Zinc oxide (Sakai Chemical Industry Co., Ltd.; average particle size, 0.5 μm)
Barium sulfate (Sakai Chemical Industry Co., Ltd.; average particle size, 0.1 μm)
Peroxide (dicumyl peroxide available from NOF Corporation)

### Deflection

The golf ball was placed on a steel plate, and the deflection (mm) of the ball when compressed under a final load of 1,275 N (130 kgf) from an initial load of 98 N (10 kgf) was measured. This test was carried out at 23±1° C.

### Initial Velocity

The initial velocity was measured using an initial velocity measuring apparatus of the same type as the USGA drum rotation-type initial velocity instrument approved by the R&A. The ball was temperature-conditioned for at least 3 hours at 23±1° C., then tested at the same temperature by being hit with a 250 pound (113.4 kg) head (striking mass) at an impact velocity of 143.8 ft/s (43.83 m/s). Ten balls were each hit twice. The time taken for a ball to traverse a distance of 6.28 ft (1.91 m) was measured and used to compute the initial velocity of the ball. This cycle was carried out over a period of about 15 minutes.

### Coefficient of Restitution (COR)

The ball was fired from an air cannon against a steel plate at a velocity of 43 m/s, and the rebound velocity was measured. The coefficient of restitution (COR) is the ratio of the rebound velocity to the initial velocity of the ball.

### Shot Number (Durability)

The durability of the golf ball was evaluated using an ADC Ball COR Durability Tester manufactured by Automated Design Corporation (U.S.). A ball was fired using air pressure and made to repeatedly strike two metal plates arranged in parallel. The average number of shots required for the ball to crack was treated as its durability. These average values were obtained by furnishing four balls of the same type for testing, repeatedly firing each ball until it cracked, and averaging the number of shots required for the four balls to crack. The type of tester used was a horizontal COR durability tester, and the incident velocity of the balls on the steel plates was 43 m/s.

1. A golf ball material which is comprised of a polymer material that contains spherical inorganic particulates and is well adapted for use in at least one component of a golf ball composed of one or more layers.

2. The golf ball material of claim 1, wherein the spherical inorganic particulates have a sphericity, expressed as a ratio of maximum diameter to minimum diameter, in a range of from about 1.00 to about 2.00.

3. The golf ball material of claim 1, wherein the spherical inorganic particulates have a thermal expansion coefficient, under conditions of 5 hours at 100° C., of at most about 2.0%.

4. The golf ball material of claim 1, wherein the spherical inorganic particulates have an average particle size in a range of from about 0.01 μm to about 100 μm.

5. The golf ball material of claim 1, wherein the spherical inorganic particulates have an average specific surface area, as measured by the BET method, of from about 0.05 m²/g to about 115 m²/g.

6. The golf ball material of claim 1, wherein the spherical inorganic particulates have a specific gravity of at least about 1.1.

7. The golf ball material of claim 1, wherein the spherical inorganic particulates are oxygen-containing inorganic compounds.

8. The golf ball material of claim 1, wherein the spherical inorganic particulates have a structure that is crystalline or noncrystalline.

9. The golf ball material of claim 1, wherein the polymer is a thermoplastic polymer and/or a thermoset polymer.

10. The golf ball material of claim 9, wherein the thermoplastic polymer and/or thermoset polymer is at least one polymer selected from the group consisting of polyolefin elastomers (including ethylenic ionomers, polyolefins and metallocene polyolefins), polystyrene elastomers, diene polymers, polyacrylate polymers, polyamide elastomers, polyurethane elastomers, polyester elastomers, polyacetals, thermoset urethanes and silicone polymers.

11. The golf ball material of claim 10, wherein the spherical inorganic particulates are included in an amount of from about 0.1 parts by weight to about 30 parts by weight per 100 parts by weight of the thermoplastic polymer and/or thermoset polymer.

12. A golf ball comprising the golf ball material of claim 1, wherein the golf ball material is used as a cover material or a core material in a solid two-piece golf ball comprising a core and a cover encasing the core, or as a cover material, an intermediate layer material or a core material in a solid multi-piece golf ball comprising a core of at least one layer, at least one intermediate layer encasing the core, and a cover of at least one layer encasing the intermediate layer.
